(19) United States
(12) Patent Application Publication
(10) Pub. No.: US 2007/0019310 A1
(43) Pub. Date: Jan. 25, 2007

(54) Facet mirrors and a method for producing mirror facets

(75) Inventors: Andreas Seifert, Aalen (DE); Frank Melzer, Utzmemmingen (DE); Andreas Heisler, Steinheim (DE); Heinz Mann, Aalen (DE); Gerhard Romeyn, Oberkochen (DE)

Correspondence Address: WELSH & KATZ, LTD, 120 S RIVERSIDE PLAZA, 22ND FLOOR, CHICAGO, IL, 60606, US

(73) Assignee: CARL-ZEISS SMT AG, Oberkochen (DE)

(21) Appl. No.: 10/563,701

(22) PCT Filed: Jul. 8, 2004
(86) PCT No.: PCT/EP04/07478

§ 371 Date: Apr. 3, 2006

Related U.S. Application Data
(60) Provisional application No. 60/485,759, filed on Jul. 9, 2003.

(51) Int. Cl. G02B 5/08

(52) U.S. Cl. 359/845

(57) ABSTRACT

In a method for producing mirror facets (1) for facet mirrors in illuminating devices or projection exposure machines in microlithography by using radiation in the extreme ultraviolet range, individual tilting angles are recessed into an optical surface (2) of the mirror facet (1), preferably a surface with tilting angles relative to a reference surface of the mirror facet (1) is machined into or on said optical surface.

The invention relates to a facet mirror having a multiplicity of mirror facets in illuminating devices for projection exposure machines in microlithography using radiation in the extreme ultraviolet region, the mirror facets each having a reflecting optical surface, and the mirror facets being arranged on a mirror support body. The invention also relates to a method for producing mirror facets, and to an apparatus for positioning a mirror facet on a support body.

U.S. 2003/0058555 A1 discloses a facet mirror that has a multiplicity of mirror facets that are mounted, in turn, on a base plate. Each of the mirror facets has a reflective surface and a magnetic layer that is applied to the opposite side of the reflecting layer on the mirror facet. The mirror facets can be accurately positioned on the base plate with the aid of a positioning device. Moreover, the mirror facets are arranged on the base plate in such a way that they adjoin one another. By virtue of the fact that the base plate contains a magnet and that the mirror facets include on their underside a magnetic film or a magnetic layer, there is no need to use adhesives or other connecting means to connect the mirror facets to the base plate.

The production of such a facet mirror consists, firstly, in applying the reflecting layer to a printed circuit board. Thereafter, a multiplicity of mirror facets are cut out of the printed circuit board, the mirror facets of this type thereafter being arranged on the base plate, the mirror facets being connected to the base plate via magnetic forces such that the mirror facets form a prescribed pattern in a mutually adjoining fashion.

Furthermore, JP 2000098114 A discloses a positioning method for a mirror facet on a main plate, use being made, for accurately positioning the mirror facet, of a reference surface that is located on the main plate. Reference surfaces for positioning in a horizontal direction and a vertical direction are formed on the rear side of the. mirror facet. A block element with the associated corresponding reference surfaces is mounted on the main plate as main base for the mirror facet. The block element is of L-shaped design in this case. In this way, it is possible for a plurality of mirror facets to be joined, in combination with the block element on the main plate, to form a facet mirror.

Production and applications of mirror facets are further described in the following patent documents:
JP 2000098108, JP 2000098110, JP 2000098111, JP 2000098112, JP 2000098113, JP 2000162414, JP 2000162416, JP 2002131520.

The production of small mirror optics with, for example, a rectangularly edged optical surface can be carried out in general using the conventional standard methods of optical fabrication. If, however, the rectangular optical surface of this type should be very narrow, for example <5 mm, and if there is a tilting to be recessed into the optical surface (meaning, that the optical surface should be tilted regarding a reference surface), the limits of classical optical fabrication quickly become clearer. Such mirror facets are typically a constituent of illuminating systems for EUV lithography.

In particular, the conditions of such mirror facets for EUV lithography need to be observed (considered) in order for the facet mirror to be of very high quality. The prescribed roughnesses are to be observed here, in particular.

Consequently, the object of the invention is to create a method for producing mirror facets for a facet mirror, the mirror facets having a very narrow optical surface and having a tilted optical surface upon completion of the facet mirror.

The object is achieved by means of a method for producing mirror facets for facet mirrors as claimed in claim 1, a facet mirror as claimed in claim 19 and apparatuses for positioning mirror facets on a support body as defined in claims 23 and 26.

According to the invention, the production of facet mirrors with tilted optical surfaces is implemented by virtue of the fact that instead of rotating or tilting the mirror facet or the mirror body, the tilting angles are recessed into the optical surface of the mirror facets, meaning that the tilting angles of the optical surface of the facet mirror relative to a reference surface of said mirror is formed by the machining of the mirror without a tilt of the mirror. Consequently, the optical surface can be produced with an edge that is as sharp as possible at less than 50 μm. Furthermore, the advantage consists in that the individual mirror facets for an ensemble are or can be tightly packed, and possible light losses can thereby be minimized.

Consequently, the tilting angles are firstly recessed into the later optical surface of the mirror facet, a requirement being in this method of production to ensure, in particular, that the optical surface has a very high aspect ratio. Thereafter, the mirror facets are provided with a reflecting layer on the optical surface, and arranged tightly packed against one another on a mirror support body.

An advantageous refinement of the invention provides that, in order to set a tilting angle φₓ, the mirror facet is brought between the two bearing bodies with an oblique locating face and held there, a tilting angle φ_{y} of the mirror facet being set via a screw device that acts on a surface of the mirror facet that is situated opposite the optical surface.

A particular advantage of this method consists in that two tilting angles can be recessed into the surface of the mirror facet with very high accuracy (meaning that a surface of arbitrary shape can be formed into or on a surface of the mirror facet, whereas the formed surface may be tilted regarding one or two tilting angles relative to a reference surface, preferably relative to a reference surface of the mirror facet), it being possible here, particularly, to produce plane tilted surfaces very effectively. Owing to the bearing bodies, which frame the mirror facet, a large area can thereby be machined, and this leads, in turn, to a very high optical quality and the optical surface can therefore be produced with a sharp edge.

A further advantageous refinement of the invention provides that, in order to set tilting angles φₓ and φ_{y}, the mirror facet is arranged on a support body in a machining region of a machining tool, defined abaxially relative to an axis of the machining tool, a surface of the machining tool that machines the mirror facets being designed as a spherical or aspheric surface.

In particular, it is thereby possible for defined tilting angles to be recessed into the surface of the mirror facets using a spherical or an aspheric machining method, the mirror facet being arranged abaxially on a support body. Furthermore, given the abaxial positioning, arbitrarily edged mirror facet bodies can be used to set defined tilting angles. A further advantage exists in this case, specifically that a plurality of mirror facets can be processed simultaneously, and that several radii differing arbitrarily can now be used.

Advantageous refinements and developments of the invention emerge from the further subclaims and the following exemplary embodiments described in principle in the drawing, in which:

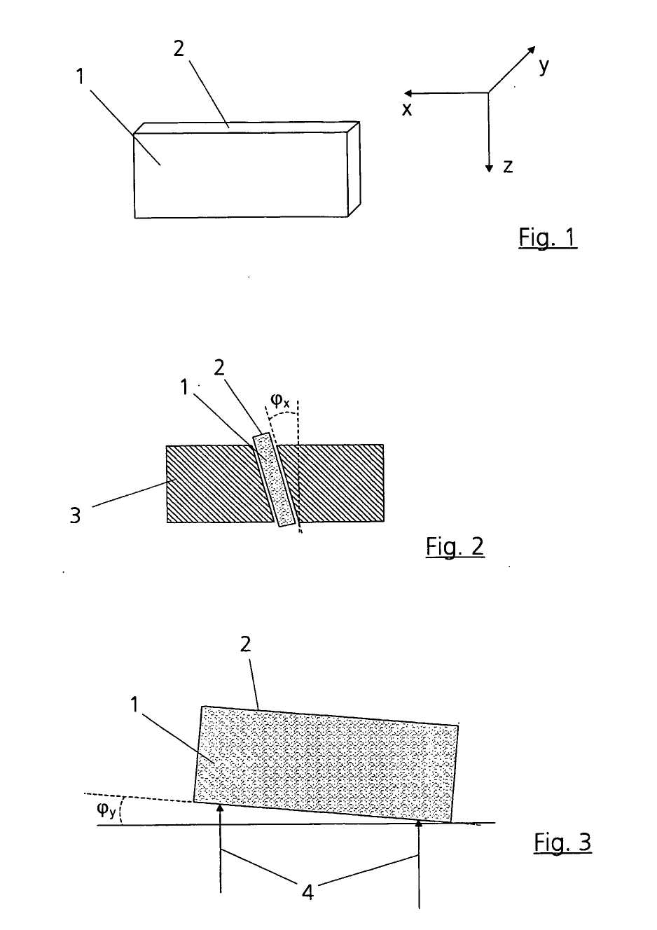

FIG. 1 shows an illustration of the principle of a mirror facet having a rectangular optical surface and a high aspect ratio;

FIG. 2 shows an illustration of the principle of a mirror facet for setting the tilting angle φₓ;

FIG. 3 shows an illustration of the principle of a mirror facet for setting a tilting angle φ_{y};

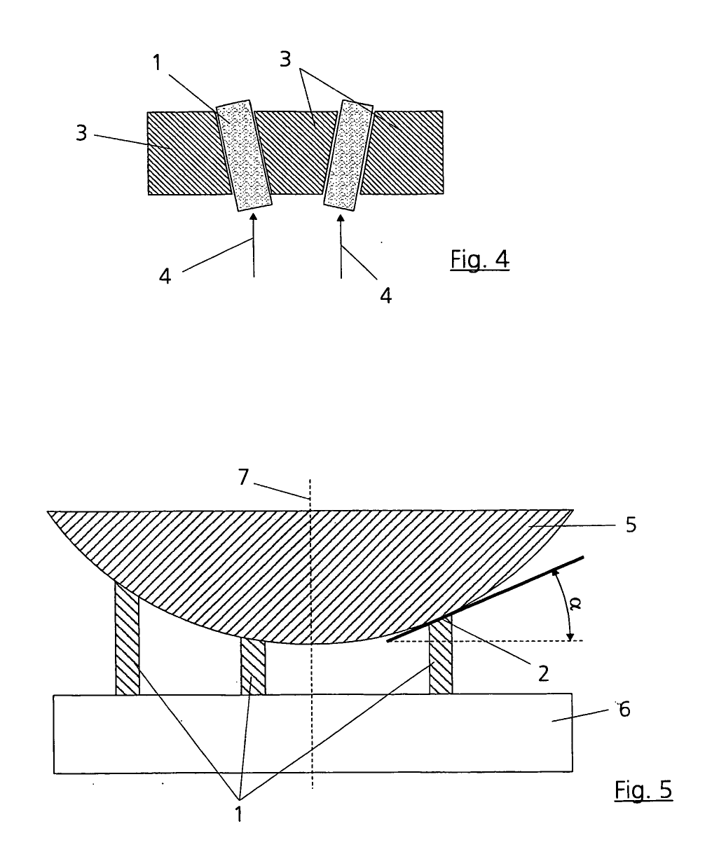

FIG. 4 shows an illustration of the principle of simultaneous machining of a plurality of mirror facets with tilting angles φₓ and φ_{y};

FIG. 5 shows an illustration of the principle of an alternative method of producing mirror facets with tilting angles that are to be inserted via an abaxial position of the mirror facet relative to a tool axis;

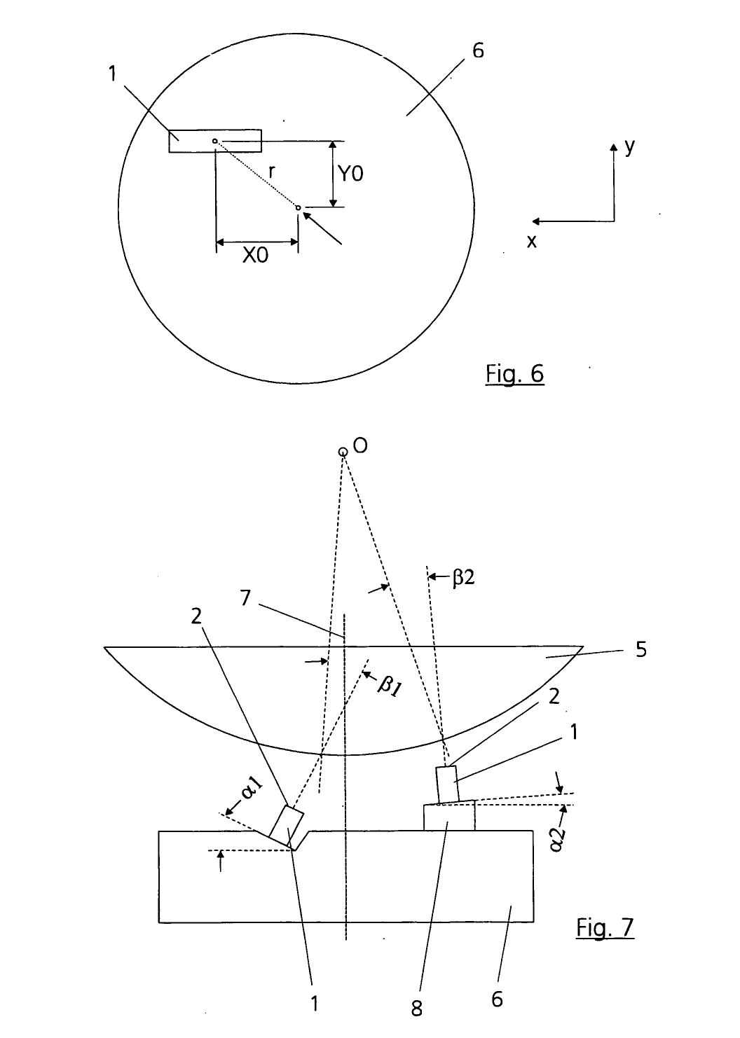

FIG. 6 shows an illustration of the principle of setting two tilting angles φₓ and φ_{y} according to FIG. 5 via a defined abaxial position of the mirror facet relative to an optical axis, in plan view;

FIG. 7 shows an illustration of the principle of a further possibility for recessing defined tilting angles into an optical surface of the mirror facet;

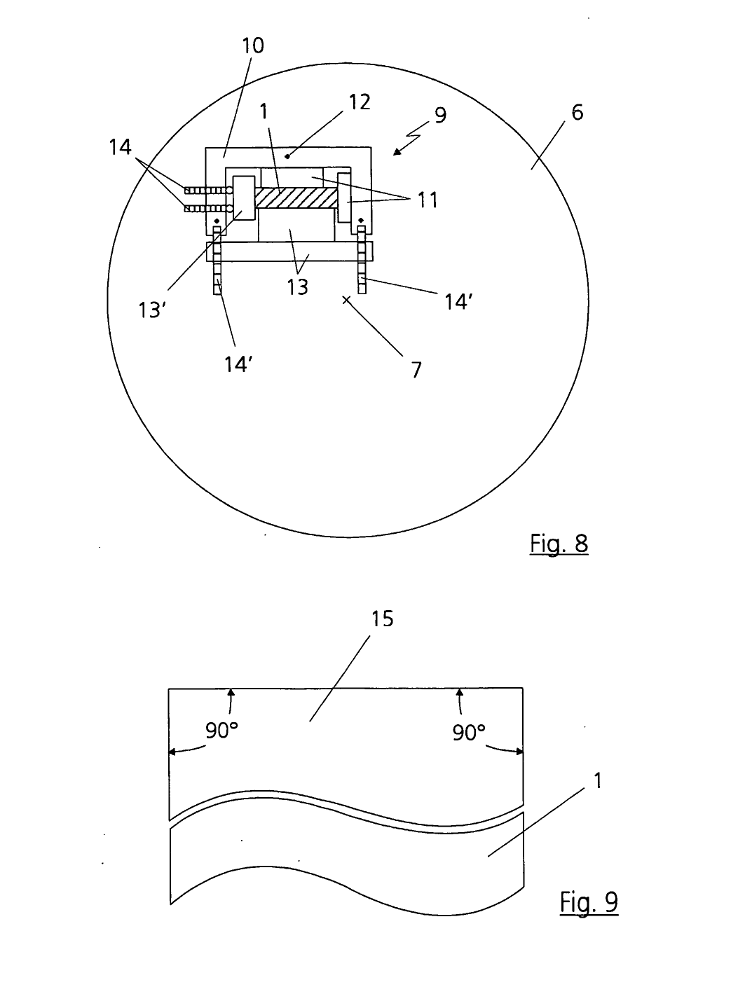

FIG. 8 shows an illustration of the principle of a positioning apparatus for a mirror facet, the mirror facet being fixed at a defined position on a support body;

FIG. 9 shows an illustration of a mirror facet with arbitrary edging and the matching adjoining auxiliary piece;

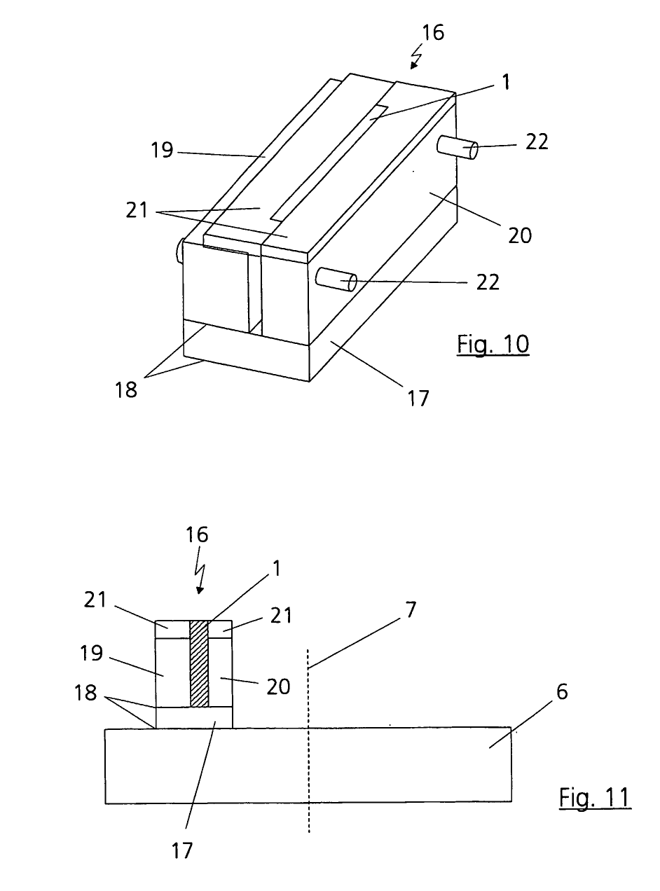

FIG. 10 shows an illustration of the principle of a further inventive apparatus for positioning a mirror facet on a support body;

FIG. 11 shows a schematic of the positioning device according to FIG. 10 after arrangement on the support body, in side view;

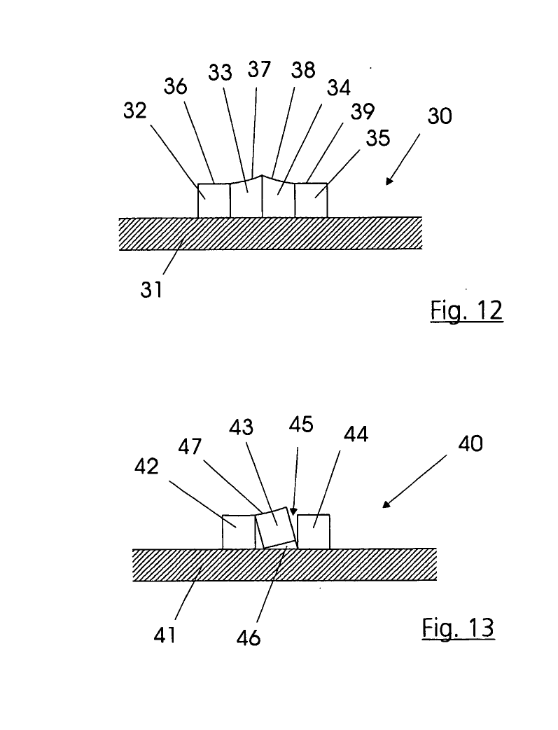

FIG. 12 shows schematically a part of a facet mirror according to the present invention; and

FIG. 13 shows schematically a part of a facet mirror without tilted optical surfaces.

Illustrated schematically in FIG. 1 is a mirror facet 1 in the case of which an optical surface 2 has a very high aspect ratio. Here, the mirror facet surface 2 has typical dimensions for EUV lithography that comprise, for example, a width of 2 to 5 mm and a length of a few 10 mm, the aim being to produce the optical surface 2 with high demands placed on the optical quality, for example on roughnesses and surface form errors. The optical surface 2 should in this case be fabricated with an edge or edges as sharp as possible (e.g. less than 50 μm) and with individual tilting angles of the optical surface 2 relative to a base surface. In this case, instead of the mirror facet being rotated or tilted, the required tilting angles are recessed into the optical surface 2. This means that the shape of the optical surface 2 (which could be a plane or a curved surface) has a normal or a normal plane with tilting angles relative to the base surface, or better relative to the normal of the base surface. This is particularly advantageous, since thereby the individual mirror facets 1 are packed tightly next to one another, and so light losses can be kept as low as possible.

A first method for machining rectangularly edged optical surfaces 2 of the mirror facet 1 with the requirements already named is shown below.

FIGS. 2 and 3 show schematically how two tilting angles can be recessed with great accuracy into the optical surface 2. In order to set a rotational angle φₓ about an x axis, the rotation angle φₓ being illustrated uniquely in FIG. 2, the mirror facet 1 can be held or clamped between two bearing bodies 3 that have oblique locating faces. The aim in this case is for the oblique locating faces that touch the mirror facet 1 to be machined flat very effectively or machined plane very effectively. In other words, the surfaces of the bearing bodies 3 which are in contact with the mirror facet 1 should be machined with an accuracy as required regarding e.g. planity and angular deviation. The oblique locating faces of the bearing bodies 3 correspond accurately to the required tilting angle φₓ about the x-axis. In this case, the tilting angle φₓ should not exceed the required tolerance in order for it to be possible to recess a highly accurately tilted surface 2 into the mirror facet 1. To recess a surface means to form an optical surface 2 on the mirror facet 1 by machining a surface of the mirror facet 1. Machining may comprise milling, grinding, lapping or polishing, or any other machining where material is removed from the surface of the mirror facet 1 to form the optical surface 2. Additionally machining may also comprise steps in which material is deposited on a surface of the mirror facet 1 to form the optical surface 2. It is advantageously possible by means of the bearing bodies 3 not only to set the tilting angle φₓ, but also to enlarge optical surface 2, which is being machined, for the machining process, so that an optical surface 2 with a sharp edge can be ensured. Due to the enlargement of the optical surface 2, border effects caused by the machining process of the optical surface 2 is transferred to the border of the bearing bodies 3, resulting in a minimisation of border effects on the mirror facet 1. Thus sharp edges of the optical surface 2 can be achieved. Given a facet height of 30 mm, and a fabrication accuracy of 0.5 μm, the oblique locating faces can thereby advantageously be fabricated with an angular error of approximately 3″.

A tilting angle φ_{y} about a short mirror facet side (y axis) can be set highly accurately by two micrometer screws 4, as is illustrated in FIG. 3. In this case, the high aspect ratio proves to be a favourable lever for fine angular setting. The mirror facet 1 can be pressed upward as far as the defined angle φ_{y} and accurately set via the micrometer screws 4. Given a spacing between the two micrometer screws 4 of approximately 50 mm, an angular accuracy of approximately 4″ can be achieved given a positioning accuracy of 1 μm for the micrometer screws 4. The setting of the tilting angle φ_{y} can be performed via the micrometer screws 4 directly at the mirror facet 1, or else via the long lever arm of a base plate. Using a base plate for setting the tilting angle, the accuracy of the tilting angle φ_{y} can be improved by a factor given by the ratio of the length of the base plate and the length of the mirror facet 1 (e.g. 50 mm). This requires that the distance of the micrometer screws 4 is defined by the length of the base plate which is adjusted by said screws 4, and on which the mirror facet 1 is attached.

The setting of the two tilting angles φₓ and φ_{y} is performed simultaneously according to the invention. Consequently, it is possible in this way during the fabrication process, for example using standard methods in optics such as grinding and polishing, for the two tilting angles φₓ and φ_{y} to be recessed simultaneously into the optical surface 2 by a machining tool, machining (milling, grinding, lapping, polishing) the optical surface 2 enlarged by the bearing bodies 3. This means that the fabrication process offers the possibility to form an arbitrary optical surface 2 (like plane or curved surfaces of any curvature e.g. spherical or aspherical surfaces), being tilted relative to the base surface of the mirror tilting angles φₓ and φ_{y} have been introduced into the optical surface 2 and after the high-accuracy quality for the optical surface 2 has been achieved, a reflecting layer can be applied to the optical surface 2. Only thereafter are the mirror facets 1 arranged and permanently mounted on a basic body for the purpose of fabricating a facet mirror.

FIG. 4 shows simultaneous recessing of the required tilting angles φₓ and φ_{y} into a plurality of mirror facets 1. Here, as well, the tilting angle φₓ is determined via the bearing bodies 3, and the tilting angle φ_{y} is set via the micrometer screws 4.

This method can be used, in particular, to produce plane optical surfaces 2 with high accuracy. It is, however, also conceivable to use this method for spherical or aspheric surfaces, in which case, when use is made of a spherical or an aspheric tool, the latter should work on the optical surface 2 provided only in a centered fashion, since otherwise the tilting angles introduced are, or can be, affected by error. Thus, however, it is possible for the mirror facets 1 clamped into the bearing bodies 3 to be machined one after another. However, it would also be possible to set the mirror facets 1 via special computer programs in such a way that the spherical or aspheric tool can simultaneously machine a plurality of mirror facets 1.

This method is likewise suitable for machining metal mirrors, and also for machining glass, glass ceramic or silicon mirrors or mirrors comprising semiconductor material. It would also be possible with the aid of this method to provide arbitrarily edged mirror facets 1 (mirror facets 1 with arbitrary shape of the optical surface 2), with tilting angles φₓ and φ_{y}, it being necessary, however, to bear in mind that the bearing bodies 3 should be provided with locating faces that correspond, in turn, to the outer surfaces of the mirror facets 1, in order thus to achieve a very high accuracy.

Furthermore, FIG. 5 indicates a possibility of producing mirror facets with tilted surfaces 2 that are not plane. In this case, after the tilting angles φₓ and φ_{y} have been recessed (meaning, after the optical surface 2 has been formed in a way that the normal or normal plane of said surface is tilted by said angles φₓ and φ_{y} relative to the base surface or the normal of said base surface of the mirror facet 1), the mirror facets can have a spherical or else an aspheric surface 2. The production method now exhibited below relates in this exemplary embodiment specifically to cuboidal mirror facet bodies 1 with requirements as specified above.

Illustrated schematically in FIG. 5 is a support body 6 on which the mirror facets 1 are arranged abaxially. If a spherical tool 5 or a spherical machining method is used to machine the optical surfaces 2 of the mirror facets 1, it is possible, via the spacing between the mirror facet 1 and a spherical axis 7 of the tool 5, for the two tilting angles φₓ and φ_{y} (axis of rotation perpendicular to the tool axis) to be recessed in a defined fashion into the optical surface 2 of the mirror facet 1. The mirror facet 1 is arranged in this case at a defined position on the support body 6. By exploiting the fact that the spherical tool 5 “rises more and more to the outside” from its axis 7 and therefore has an arbitrarily angular spectrum, the two defined tilting angles can thus be introduced into the optical surface 2 of the mirror facet 1. In FIG. 5, the tilting angle is illustrated by α, the setting of the tilting angle being shown here only in one dimension. Such with the shown method a spherical surface is formed as an optical surface 2 on a mirror facet 1. The radius of said surface is given by the tool 5 which is rotating around the rotation axis 7. Depending on the position of the mirror facet 1 relative to the rotation axis 7, the spherical surface is formed with tilting angles φₓ and φ_{y} relative to the base surface of the mirror facet 1. Is the mirror facet 1, for example, positioned symmetrically to the rotation axis 7, the tilting angles φₓ and φ_{y} are zero, meaning that the normal or the normal plane of the optical surface is perpendicular to the base surface of the mirror facet 1, or in the direction of the rotation axis 7. Is the mirror facet 1 positioned on a position other than said symmetrical arrangement, the optical surface 2 then becomes tilted relative to said base surface. In general the tool 5 has not to be spherical, also an aspherical but rotationally symmetric tool can be used for forming the optical surface 2.

Moreover, the mirror facets 1 in FIG. 5 all have a different height. If required, all the mirror facets 1 can also have the same height. This can be achieved by means of auxiliary pieces (not shown) of different height. The auxiliary pieces should be arranged below the mirror facets 1 as a function of the distance r. The correction of the height Δh is formed via the following circle or sphere formula:
Δh=\sqrt{R²−r²}+R, or Δh=R−\sqrt{R²−r²}

R being the radius of the sphere, and r being the normal distance of the centre of the mirror facet 1 to the rotation axis 7.

Analogously, it is also possible to set two tilting angles (rotation about x and y), as is illustrated in FIG. 6. In this case, the two tilting or rotational angles φₓ and φ_{y} about the axes x and y are defined for each point x and y. Coordinate conventions according to the coordinate systems as illustrated in FIGS. 1 and 6 apply. If the rotational angles φₓ and φ_{y} are defined as Euler angles, the result is the following relationship between the spatial coordinates of the mirror facet 1 (midpoint or the point at which the tilting angles are defined) and the tilting angles φₓ and φ_{y}:
XO=R sin φ_{y} and
YO=R sin φₓ cos φ_{y},
R being the radius of the spherical surface 2.

### EXAMPLE

Let the spherical radius be R=100 mm, and let φₓ=2° and φ_{y}−3.5° hold for the tilting angles φₓ and φ_{y}. The positions pertaining to the angles φₓ and φ_{y} are thus x=61.05 mm and y=−34.83 mm. If the tilting angles are small, which means <10°, the contribution to the angular error that comes about owing to the positioning of the mirror facet 1 can be estimated as follows:
Δφₓ=Δy/R and
Δφ_{y}=Δx/R,
the angles φₓ and φ_{y} being given in rad. Given a positional uncertainty of, for example, Δₓ=5 μm, the sharp reduction in the relatively large radius R results in an angle error of Δφ_{y}=5 μrad, which corresponds approximately to 1″.

Positional uncertainties of approximately 1 μm can be set using microscopic observation, for example with the aid of portal microscopes or of suitable aids such as, for example, high-accuracy end measures (or gauge blocks), and tilting angles can thereby be achieved with an accuracy of 1 μrad.

However, it is possible thereby for this method of the abaxial positioning to be carried out without any problem to set defined tilting angles with the aid of arbitrarily edged mirror facet bodies 1, and this method is likewise not restricted to spherical surfaces. It is also possible in this way to produce mirror facets 1 with tilted aspheric surfaces 2.

A further possibility is shown according to the invention in FIG. 7, specifically how optical surfaces 2 tilted in a defined fashion independently of the position can be produced. The advantage of this possibility is that there is no need for the distance of the mirror facet 1 from the axis 7 of the spherical or aspheric machining tool 5 to be accurately controlled and for the mirror facet 1 to be fixed at the correct position for the machining. Consequently, the machining method exhibited below for the mirror facet 1 is much more flexible, and thus more production-friendly, since the required tilting angles φₓ and φ_{y} are recessed into the support body 6, or a body 8 machined as a wedge is placed onto the support body 6. The body machined as a wedge or the auxiliary piece 8 serves here as support for the mirror facet 1. Two angles are set simultaneously, specifically the angle α and the, angle β, as may be seen from FIG. 7. However, in this case the wedge angle α does not correspond exactly to the angle that is recessed into the optical surface 2 in the final analysis. Consequently, the wedge angle a must be corrected by the contribution that comes about owing to the deviation of the mirror normal from the tool normal at the mirror midpoint O. The wedge angle a should thus be set corresponding to the selected position and taking account of the angular correction β. This can be performed with the aid of appropriate computing operations. The wedge angles are respectively denoted by α in FIG. 7 for the two methods and the angular difference between the mirror normals and the radial beams in the tool 5 are specified by β.

The angle β is very small in the case of flat radii, for example R˜1000 mm, and then constitutes only a correction to the wedge angle α that essentially sets the tilt. The aim in FIG. 7 is to illustrate the principle with the aid of the detectable angle β. The method, which is shown in this exemplary embodiment only for one angle, is likewise valid for two dimensions or two tilting angles.

The method according to the invention therefore permits the mirror facets 1 to be positioned at virtually any desired positions on the support body 6 in order to produce a surface 2, tilted in a spherically or an aspherically defined fashion, with arbitrary angles.

If the optical surface 2 is machined with the aid of a spherical or aspheric tool 5, the two tilting angles φₓ and φ_{y} can be recessed into the optical surface 2 in a fashion defined via the distance between the mirror facet 1 and the spherical axis 7. The angular error is examined in this case via the positional uncertainty of the mirror facet 1, and is particularly small whenever the radius R of the tool 5 or the radius of the spherical or aspheric surface 2 becomes large.

The position of the optical axis or of the tool axis 7 must be known ih this case with sufficient accuracy.

When producing mirror facets 1 with an aspheric optical surface 2, it can be advantageous to recess three tilting angles, specifically φₓ, φ_{y} and φ_{z}, into the optical surface 2.

FIG. 8 shows a first possibility of how a mirror facet 1 can be positioned and held in a defined fashion on the support body 6 for the machining process. A positioning and holding device 9 can be provided here. The positioning and holding device has in this case a U-shaped body element 10. The mirror facet 1 is introduced into the cut-out in the U-shaped element 10, and the mirror position is set with reference to the inner surfaces of the U-shaped body element 10. The U-shaped body element 10 can consists, for example, of a metal, ceramic or a material resembling glass, and the inner surfaces should be fabricated with high accuracy. Consequently, the U-shaped body element 10 can be positioned on the support body 6 in a fashion defined relative to a zero point, for example the tool axis 7. There is no need here for the highly accurate positioning of the U-shaped body element 10 on the support body 6, since an accurate positioning of the mirror facet 1 can be achieved via end measures 11. The U-shaped body element 10 can be positioned precisely on the support body 6 via centering pins 12, it being possible, in addition, for the U-shaped body element 10 further to be fastened to the support body 6, for example to be screwed on. The final mirror facet position can therefore now be adjusted via the high-accuracy end measures 11, for example made from metal or ceramic.

The fabrication of the U-shaped body element 10, and the position of the centering bores 12 need not necessarily be machined very precisely. The position of the finally mounted U-shaped body element 10 can be determined, for example, with the aid of a coordinate measuring machine, and subsequently the mirror position can be fixed relatively to the axis of symmetry 7 of the tool 5 via the high-accuracy end measures 11.

The mirror facet 1 can now be pressed against the end measures 11 via suitable clamping elements 13, it being possible, for the purpose of clamping the long facet side, to press the corresponding clamping element against the U limbs of the body element 10 with the aid of screw elements 14′ and fasten it there. Through holes can be present for this purpose in the corresponding clamping element 13, and threads can be present in the U-shaped body element 10 or U limbs. Suitable spring elements for clamping could also be used here. A clamping element 13′ that is mounted on the short facet side of the mirror facet 1 can be pressed against the mirror facet 1 via two screw elements 14 that have a spherical end in this exemplary embodiment. Threaded bores are likewise required for this purpose in the U-shaped body element 10. Here, as well, clamping can be implemented via suitable spring elements.

Since the level in the spherical surface of the tool 5 varies as a function of the mirror position, the differences in level can be balanced out, if appropriate, with the aid of a defined base plate, for example an end measure that can be mounted below the mirror facet 1. The correction of the level is performed via the circle or sphere formula already stated:
Δh=\sqrt{R²−r²}+R, or Δh=R−\sqrt{R²−r²}

R once again representing the radius of the sphere of the tool 5, r being the distance of the mirror midpoint or of the point on the mirror facet 1 at which the tilting angles are specified from the axis of rotation of the tool 5. In order to be able to machine the edges of the mirror facets 1 as sharply as possible, they can be surrounded with accurately fabricated and accurately measured auxiliary elements 15 of the same height and the same material as illustrated in figure 9. Since it is also possible for arbitrarily edged mirror facets 1 to be executed with the aid of the possibilities stated here for introducing the tilting angles into the optical surface 2, the auxiliary pieces 15 should have exactly the corresponding outer surfaces or location faces in relation to the mirror facets 1. The end measures 11 should then be matched correspondingly to the arbitrarily edging.

The methods of abaxial positioning for setting defined tilting angles can therefore be carried out with arbitrarily edged mirror facet bodies 1 and is not restricted to aspherical, spherical or plane surfaces. Mirror facets 1 with tilted aspheric surfaces can also be fabricated or produced in the same way. If, for example, the mirror surface 1 are not rectangularly edged, use can be made, as shown in FIG. 9, of the adjacent auxiliary piece 15 with the same edging on the side facing the mirror facet 1 and a plane surface on the side adjacent to the end measure 11.

FIGS. 10 and 11 show a further possibility for holding the mirror facet 1 at a defined position in the machining process on the support body 6, which is not illustrated in FIG. 10. Here, the mirror facet 1 is mounted into a separate module 16 that is fastened at a defined position on the carrier plates 6 under observation or continuous control. The fastening of the module 16 on the carrier plate 6 can be performed by wringing, although flexibility continues to be ensured in the process. The module 16 is composed of an individually adjustable mirror facet support 17 on which the mirror facet 1 is mounted. The mirror support 17 can have a wringing surface 18 both at the top and at the bottom. The lower wringing surfaces 18 serves the purpose of fixing in a defined fashion on the support body 6 for the machining process, while the top wringing surfaces 18 serves for a bearing element 19 that is likewise wrung onto the mirror support 17. Together with the mirror support 17, the bearing element 19 serves as angle reference surface for the transverse angle of the facet (rotation about the x axis). The mirror support 17 and the bearing element 19 as well as the wringing surface 18 on the support body 6 must be fabricated in accordance with the required angular tolerances. The mirror facet 1 is laid against the bearing element 19 bearing element 19 and fixed via the clamping element 20. Auxiliary elements 21 are arranged about the mirror facet 1 and serve as an edge overflow or an extension of the produced mirror surface in order to enlarge the machining surface 2 of the mirror facet 1 and to avoid edge effects on the mirror facet 1. The clamping element 20 can be connected to the bearing element 19 directly via screw element 22 in order to position the mirror facet 1 accurately in the module 16, the screw elements 22 not being illustrated in FIG. 11.

The module 16 can be fixed in further ways on the carrier plate 6 for the machining process, for example via magnetic holders, use being made of magnets that can be switched on and off. Furthermore, the fixing can also be performed by vacuum clamping, bonding or cementing, in which case a defined bonding area should be present when use is made of adhesive or cementing means, in order to comply with the tilting angle tolerances.

The fixing of the mirror facet 1 and the module 16 on the carrier body 6 should take place under observation in all instances when no fixed position is prescribed, for example by bores on the carrier body 6. It is also possible to operate with defined stops that uniquely define the position of the mirror facet 1 on the support body 6, and thus in relation to the axis of symmetry (tool axis) 7.

FIG. 12 shows schematically a part of a facet mirror 30 according to the present invention. A plurality (at least two) mirror facets 32, 33, 34, 35 are arranged on a mirror support 31. In this embodiment the mirror facets 32 and 35 each have an optical surface 36, 39 which is not tilted regarding a reference surface of the respective mirror facets. As reference surfaces in this case the surfaces contacting the mirror support 31 are chosen, which in the shown embodiment is a plane surface. The mirror facets 33, 34 are produced according to the method of the present invention with e.g. an apparatus of the present invention, having optical surfaces according to the present invention. This means that the mirror facet has at least one optical surface whose normal or normal plane is tilted by at least one tilting angle or two tilting angles relative to the normal or normal plane of a reference surface of the mirror facet. Here, also the reference surface is the surface which contacts the mirror support.

Using mirror facets 33, 34 according to the present invention allow the formation of a compact facet mirror 30 with the advantage that the geometrical projection of the optical surfaces of two adjacent mirror facets like 32, 33 or 34, 35 or 33, 34 onto the support body 31 cover at least an area of the same size as the geometrical projection of the respective mirror facets onto said support body 31. This feature holds especially for adjacent mirror facets with at least one tilted optical surface, meaning that at least one mirror facet of adjacent mirror facets has at least one tilted optical surface as it is the case for the mirror facets 33, 34 with their respective tilted surfaces 37 and 38. The tilted optical surfaces can be plane, spherical or aspherical or can have a curved structure, such that a normal or normal plane differs from the one's of the reference surface. Of course the optical surfaces can be concave or convex in one or two directions, or can be both concave in one and convex in another direction. Advantageously the reference surface is the surface essential opposite to the optical surface of the mirror facet of this invention.

Due to the advantage regarding the mentioned projections with the inventive facet mirror an area or surface of the support body 31 can be covered with optical surfaces like mirrors without getting leaks of optical surfaces on said area or surface of the support body. To show this advantage more clearly it is referred to FIG. 13, showing also schematically a part of a facet mirror 40 in which mirror facets 42, 43, 44 are used without having tilted optical surfaces according to the present invention. Mirror facet 43 has a concave optical surface and its normal plane is not tilted relative to the normal plane of the respective reference surface. In this case the reference surface is the surface adjacent to an auxiliary element 46. The auxiliary element 46 supports the mirror facet 43 such that the same optical behaviour is achieved as in the embodiment of FIG. 12. The application of auxiliary elements in producing facet mirrors or for holding mirrors is described in U.S. Pat. Nos. 4,277,141, 4,195,913 and DE 197 35 831 or in the unpublished U.S. Ser. No. 09/888,214 filed by the applicant.

Such due to the special arrangement the mirror facets 42 and 43 correspond to the mirror facets 32 and 33 of the facet mirror 30 of FIG. 12. Since the optical surface 47 of the mirror facet 43 is not formed according to the present invention, the whole mirror facet 43 have to be tilted, resulting in a gap 45 (or a leak of the optical surface) between the tilted mirror facet 43 and the other adjacent mirror facet 44. Of course the other adjacent mirror facet 44 can be formed with an optical surface which corresponds to the respective surface of the respective mirror facet 34 of FIG. 12.

Preventing or minimising leaks or gaps 45 in the optical surface of the facet mirror 30 has the advantage that the efficiency for reflection is optimized, even for mirrors with a complex reflection pattern.

The present invention should not be limited to the described embodiments. Additional embodiments of the present invention may be achieved by combining and/or exchanging features of the various described embodiments.

1-28. (canceled)

29. A method for producing mirror facets for facet mirrors in illuminating devices for projection exposure machines in microlithography by using radiation in the extreme ultraviolet region, wherein individual tilting angles are recessed into an optical surface of the mirror facet.

30. A method for producing mirror facets for facet mirrors in illuminating devices for projection exposure machines in microlithography by using radiation in the extreme ultraviolet region, wherein a surface with tilting angles relative to a reference surface of the mirror facet is machined into or on said optical surface.

31. A method for producing mirror facets for a facet mirror by providing a mirror facet, and by recessing or machining a reflecting optical surface into or on the mirror facet.

32. The method as claimed in claim 31, wherein an edge of the mirror facet has a sharpness of less than 50 micrometer.

33. The method as claimed in claim 31, wherein the optical surface has a tilting angle.

34. The method as claimed in claim 33, wherein the tilting angle has an accuracy of less than 3″.

35. The method as claimed in claim 32, wherein the mirror facet has an aspect ratio of length to width in the range of 2 to 25.

36. The method as claimed in claim 34, wherein the tilting angle is the angle between the normals of the optical surface and the base or reference surface of the mirror facet.

37. The method as claimed in claims 29 or 30, wherein after being recessed or machined the mirror facet is subsequently provided with a reflecting layer on the optical surface, and then the mirror facet is arranged on a mirror support body.

38. The method as claimed in claims 29 or 30, wherein the optical surface comprises a very high aspect ratio.

39. The method as claimed in claims 29 or 30, wherein the surface of the mirror facet is of plane, spherical or aspheric design.

40. The method as claimed in claims 29 or 30, wherein two tilting angles are recessed into the optical surface of the mirror facet.

41. The method as claimed in claims 29 or 30, wherein for setting a tilting angle φₓ, the mirror facet is brought between two bearing bodies with oblique locating faces and held there.

42. The method as claimed in claims 29 or 30, wherein a tilting angle φ_{y} of the mirror facet is set by a screw device, acting on a surface of the mirror facet that is situated opposite the optical surface.

43. The method as claimed in claim 41, wherein the tilting angles φₓ and φ_{y} are simultaneously recessed into or formed on the optical surface of the mirror facet.

44. The method as claimed in claims 29 or 30, wherein for setting tilting angles φₓ and φ_{y}, the mirror facet is arranged on a support body in a machining region of a machining tool, defined abaxially relative to an axis of the machining tool, a surface of the machining tool that machines the mirror facets being designed as a spherical or aspheric surface.

45. The method as claimed in claim 44, wherein the mirror facets are mounted on the support body by auxiliary members.

46. The method as claimed in claim 44, wherein the mirror facet is fixed on the support body in a positioning and holding device.

47. The method as claimed in claim 46, wherein the mirror facet is aligned in the positioning and holding device on inner surfaces of a U-shaped body element.

48. The method as claimed in claim 47, wherein the positioning and holding device is positioned on the support body by centering pins and is screwed on.

49. The method as claimed in claim 44, wherein the mirror facet is mounted in a structural unit, the structural unit subsequently being arranged at a defined abaxial position on the support body.

50. The method as claimed in claim 49, wherein the structural unit is fixed on the support body by at least one of the fastening techniques using magnetic or vacuum clamping or by wringing.

51. The method as claimed in claim 49, wherein the structural unit is bonded or cemented on the support body.

52. The method as claimed in claims 29 or 30, wherein the mirror facet is arranged arbitrarily on a support body in the machining region of a machining tool, a surface of the machining tool that machines the mirror facets being designed as a spherical or aspheric surface, the required tilting angles being recessed into the support body, the mirror facet being arranged on an oblique locating surface produced by the recessing of the tilting angles.

53. The method as claimed in claims 29 or 30, wherein the mirror facet is arranged arbitrarily on a support body in the machining region of a machining tool, a surface of the machining tool that machines the mirror facets being designed as a spherical or aspheric surface, an auxiliary body corresponding to the required tilting angles being mounted on the support body, the mirror facet being arranged on the auxiliary body.

54. The method as claimed in claim 52, wherein the tilting angles being corrected by an amount caused by a deviation of a mirror normal from a tool normal at a mirror midpoint.

55. A facet mirror comprising at least two mirror facets produced according to one of claims 29, 30 or 31.

56. The facet mirror as claimed in claim 55, wherein the surface geometry of the mirror facets is plane, spherical or aspheric.

57. The facet mirror as claimed in claim 55, defined by use at wavelengths of λ<200 nm.

58. The facet mirror as claimed in claim 55, wherein the at least two mirror facets comprise different tilting angles.

59. A facet mirror comprising a base and a multiplicity of mirror facets in illuminating devices for projection exposure machines in microlithography making use of radiation in the extreme ultraviolet region, the respective mirror facets comprising a reflecting optical surface with tilting angles between the normals of the optical surface and the base or a reference surface of the mirror facet, wherein more than 3 mirror facets have different tilting angles.

60. The facet mirror according to claim 55, wherein an edge of the mirror facet has a sharpness of less than 50 micrometer.

61. A positioning apparatus for a mirror facet on a support body, whereas tilting angles are recessed into an optical surface of the mirror facet or a surface with tilting angles relative to a reference surface of the mirror facet is machined into or on said optical surface, the apparatus comprising
an U-shaped body element, the mirror facet being introduced into a cut-out in the U-shaped element,
end measures for fixing a mirror facet position, and
clamping elements for pressing the mirror facet against the end measure.

62. The apparatus as claimed in claim 61, wherein the U-shaped body element is positioned on the support body by centering pins, or is permanently connected to the support body.

63. A positioning apparatus for positioning a mirror facet on a support body, whereas tilting angles are recessed into an optical surface of the mirror facet or a surface with tilting angles relative to a reference surface of the mirror facet is machined into or on said optical surface, the apparatus comprising
a mirror facet support on which the mirror facet is mounted,
a locating element that is mounted on the mirror facet support, the mirror facet being arranged on a free side of the locating element,
a clamping element that is mounted on the mirror facet support, a free side of the clamping element being arranged on a free side of the mirror facet, and
auxiliary elements for enlarging the machining area of the mirror facet.

64. The apparatus as claimed in claim 63, defined by being wrung on the support body.

65. A facet mirror comprising a plurality of mirror facets in an illumination device for projection exposure machines in microlithography, making use of radiation in the extreme ultraviolet region, the mirror facets each comprising a reflecting optical surface, and the mirror facets being arranged on a mirror support body, wherein more than three mirror facets have at least one optical surface whose normal or normal plane is tilted by different tilting angles relative to the normal or normal plane of a reference surface of said mirror facet, and wherein the geometrical projection of the optical surfaces of two adjacent mirror facets with at least one tilted optical surface onto the support body cover at least an area of the same size as the geometrical projection of the respective mirror facets onto said support body.

66. A facet mirror of claim 65, wherein the optical surfaces of the mirror facets comprise a plane, spherical or aspherical geometry.
